(19) United States
(12) Patent Application Publication
(10) Pub. No.: US 2024/0294386 A1
(43) Pub. Date: Sep. 5, 2024

(54) METHOD AND DEVICE FOR MANUFACTURING CARBON MONOXIDE

(71) Applicant: SUMITOMO SEIKA CHEMICALS CO., LTD., Kako-gun, Hyogo (JP)

(72) Inventors: Hirotaka NAKAJIMA, Kako-gun, Hyogo (JP); Hiroyasu SATO, Kako-gun, Hyogo (JP)

(21) Appl. No.: 18/571,878

(22) PCT Filed: Jun. 16, 2022
(86) PCT No.: PCT/JP2022/024147

§ 371 Date: Dec. 19, 2023

(30) Foreign Application Priority Data
Jun. 23, 2021 (JP) 2021-104175
Jun. 23, 2021 (JP) 2021-104254

(51) Int. Cl. C01B 32/40; B01J 8/02; B01J 29/06; B01J 35/61

(52) U.S. Cl. CPC C01B 32/40; B01J 8/0278; B01J 29/06; B01J 35/615; B01J 35/617

(57) ABSTRACT

Provided is a method for manufacturing carbon monoxide, including a step of generating carbon monoxide by a decomposition reaction of at least one raw material of formic acid or formic acid alkyl ester in the presence of a solid acid catalyst, in which the solid acid catalyst has a BET specific surface area of 590 m²/g or less.

### TECHNICAL FIELD

The present disclosure relates to a method and a device for manufacturing carbon monoxide.

### BACKGROUND ART

In the related art, known examples of a method for manufacturing carbon monoxide include a method for manufacturing carbon monoxide by steam-reforming natural gas, a method for manufacturing carbon monoxide by bringing a light hydrocarbon and oxygen into contact with each other in the presence of a partial oxidation catalyst (see Patent Literature 1 described below), and a method for manufacturing carbon monoxide by decomposing formic acid. Among these, the method for manufacturing carbon monoxide by decomposing formic acid is advantageous from the viewpoint of obtaining carbon monoxide with high selectivity. Known examples of the method for manufacturing carbon monoxide by decomposing formic acid include a method of using a mineral acid and a method of using a solid acid catalyst. Among these, the method of using a solid acid catalyst is considered promising as a method for manufacturing carbon monoxide at a high conversion ratio.

### CITATION LIST

### Patent Literature

[Patent Literature 1] Japanese Unexamined Patent Publication No. 2019-181375

### SUMMARY OF INVENTION

### Technical Problem

However, the method for manufacturing carbon monoxide using a solid acid catalyst still has room for improvement in terms of the conversion ratio of raw materials.

Therefore, an object of the present disclosure is to provide a method and a device for manufacturing carbon monoxide, which can improve the conversion ratio of raw materials.

### Solution to Problem

The present inventors conducted intensive examination to achieve the above-described object. Specifically, the examination was conducted by focusing on the BET specific surface area of the solid acid catalyst. In general, the contact area between a raw material and a solid acid catalyst increases as the BET specific surface area increases, and thus the present inventors expected that the raw material is effectively decomposed by increasing the BET specific surface area of the solid acid catalyst, and as a result, the conversion ratio of the raw material can be improved. However, it was found that, unexpectedly, the conversion ratio of the raw material increases as the BET specific surface area of the solid acid catalyst decreases. Therefore, as a result of intensive research repeatedly conducted by the present inventors based on such findings, it was found that the above-described object can be achieved by the following disclosure.

That is, according to one aspect of the present disclosure, there is provided a method for manufacturing carbon monoxide, including: a step of generating carbon monoxide by a decomposition reaction of at least one raw material of formic acid or formic acid alkyl ester in the presence of a solid acid catalyst, in which the solid acid catalyst has a BET specific surface area of 590 m²/g or less.

According to the present disclosure, the conversion ratio of the raw material can be improved as compared with a case where the BET specific surface area of the solid acid catalyst is greater than 590 m²/g. Therefore, according to the method for manufacturing carbon monoxide of the present disclosure, carbon monoxide can be efficiently manufactured.

Further, according to the present disclosure, the concentration of hydrogen in carbon monoxide to be manufactured can be sufficiently reduced without performing a purification step of removing hydrogen as compared with a case where the solid acid catalyst has a BET specific surface area of greater than 590 m²/g. Therefore, according to the method for manufacturing carbon monoxide of the present disclosure, high-purity carbon monoxide can also be efficiently manufactured at a low cost.

According to another aspect of the present disclosure, there is provided a device for manufacturing carbon monoxide, which generates carbon monoxide by a decomposition reaction of at least one raw material of formic acid or formic acid alkyl ester in the presence of a solid acid catalyst, the device including: a reactor storing the solid acid catalyst and generating carbon monoxide by the decomposition reaction of the raw material in the presence of the solid acid catalyst, in which the solid acid catalyst has a BET specific surface area of 590 m²/g or less.

According to the device for manufacturing carbon monoxide, when carbon monoxide is generated by a decomposition reaction of at least one raw material of formic acid or formic acid alkyl ester in the reactor in the presence of the solid acid catalyst, the conversion ratio of the raw material can be improved as compared with a case where the solid acid catalyst has a BET specific surface area of greater than 590 m²/g or less. Therefore, according to the device for manufacturing carbon monoxide of the present disclosure, carbon monoxide can also be efficiently manufactured.

Further, according to the device for manufacturing carbon monoxide described above, when carbon monoxide is generated by a decomposition reaction of at least one raw material of formic acid or formic acid alkyl ester in the reactor in the presence of the solid acid catalyst, the concentration of hydrogen in carbon monoxide to be manufactured can be sufficiently reduced without performing a purification step of removing hydrogen as compared with a case where the solid acid catalyst has a BET specific surface area of greater than 590 m²/g. Therefore, according to the device for manufacturing carbon monoxide of the present disclosure, high-purity carbon monoxide can also be efficiently manufactured at a low cost.

In the method or device for manufacturing carbon monoxide described above, the solid acid catalyst is, for example, a proton-type zeolite.

In the method or device for manufacturing carbon monoxide, a Si/Al atom ratio of the proton-type zeolite is preferably in a range of 1 to 200.

In this case, the catalyst activity of the zeolite tends to be further improved, and the conversion ratio of the raw material tends to be improved.

In the method for manufacturing carbon monoxide, it is preferable that the decomposition reaction of the raw material is performed at 100° C. to 300° C.

In this case, the decomposition reaction tends to advance efficiently while generation of by-products such as hydrogen is suppressed and the concentration of hydrogen in carbon monoxide to be manufactured is sufficiently reduced.

In the method or device for manufacturing carbon monoxide, the solid acid catalyst has a BET specific surface area of preferably 480 m²/g or less.

In this case, the concentration of hydrogen in carbon monoxide to be manufactured can be more sufficiently reduced without performing a purification step of removing hydrogen.

### Advantageous Effects of Invention

According to the present disclosure, it is possible to provide a method and a device for manufacturing carbon monoxide, which can improve a conversion ratio of a raw material.

Further, according to the present disclosure, it is possible to provide a method and a device for manufacturing carbon monoxide, which can sufficiently reduce the concentration of hydrogen in carbon monoxide to be manufactured without performing a purification step of removing hydrogen.

### BRIEF DESCRIPTION OF DRAWINGS

FIG. 1 is a schematic view showing an embodiment of a device for manufacturing carbon monoxide of the present disclosure.

### DESCRIPTION OF EMBODIMENTS

Hereinafter, embodiments of the present disclosure will be described in detail. However, the present disclosure is not limited to the following embodiments.

According to the present disclosure, a method for manufacturing carbon monoxide includes a step of generating carbon monoxide by a decomposition reaction of at least one raw material of formic acid or formic acid alkyl ester in the presence of a solid acid catalyst. A solid acid catalyst having a BET specific surface area of 590 m²/g or less is used as the solid acid catalyst. The method for manufacturing carbon monoxide according to the present disclosure can be performed, for example, by using a device for manufacturing carbon monoxide, including a reactor that stores the solid acid catalyst and generates carbon monoxide by the decomposition reaction of the raw material in the presence of the solid acid catalyst.

### (Solid Acid Catalyst)

The solid acid catalyst is not particularly limited, but as the solid acid catalyst, for example, a proton-type zeolite is suitably used. Examples of the proton-type zeolite include zeolite such as mordenite, ZSM-5, beta-type zeolites, Y-type zeolites, and US-Y type zeolites. As the proton-type zeolite catalyst, for example, a high-silica zeolite catalyst (manufactured by Tosoh Corporation) can be used.

The solid acid catalyst has a BET specific surface area of 590 m²/g or less. When the solid acid catalyst has a BET specific surface area of 590 m²/g or less, the conversion ratio of the raw material can be improved as compared with a case where a solid acid catalyst having a BET specific surface area of greater than 590 m²/g is used. Further, when the solid acid catalyst has a BET specific surface area of 590 m²/g or less, the concentration of hydrogen in carbon monoxide to be manufactured can be sufficiently reduced without performing a purification step of removing hydrogen as compared with a case where a solid acid catalyst having a BET specific surface area of greater than 590 m²/g is used.

The BET specific surface area of the solid acid catalyst is preferably 580 m²/g or less, more preferably 550 m²/g or less, and still more preferably 500 m²/g or less. From the viewpoint of sufficiently reducing the concentration of hydrogen in carbon monoxide to be manufactured without performing a purification step of removing hydrogen, the BET specific surface area of the solid acid catalyst is preferably 480 m²/g or less, more preferably 450 m²/g or less, and still more preferably 400 m²/g or less.

However, the BET specific surface area of the solid acid catalyst is preferably 100 m²/g or greater, more preferably 200 m²/g or greater, and particularly preferably 300 m²/g or greater. In a case where the solid acid catalyst has a BET specific surface area of 100 m²/g or greater, the decomposition reaction of the raw material tends to proceed more easily, and as a result, the conversion ratio of the raw material tends to be further improved.

The BET specific surface area is a value measured under the following conditions using BEL SORP-MAX (manufactured by MicrotracBEL Corp.) as an analysis device.

### (Conditions)

Measurement temperature: −196° C.
Adsorbate: nitrogen
Equilibrium absorption time: 300 seconds
Conditions for pretreatment of solid acid catalyst: heat treatment (350° C., 5 h) in vacuum (pump specification: ultimate pressure of 6.7×10⁻⁷ Pa or less)

The Si/Al atom ratio of the proton-type zeolite used as the solid acid catalyst is not particularly limited, but is preferably 1 or greater and more preferably 5 or greater. In a case where the Si/Al atom ratio thereof is 1 or greater, the catalyst activity of the zeolite tends to be further improved, and the conversion ratio of the raw material tends to be improved. The Si/Al atom ratio thereof is preferably 200 or less, more preferably 150 or less, still more preferably 100 or less, and particularly preferably 50 or less. In a case where the Si/Al atom ratio is 200 or less, the catalyst activity of the zeolite tends to be further improved, and the conversion ratio of the raw material tends to be improved. Accordingly, from the viewpoint of improving the conversion ratio of the raw material, the Si/Al atom ratio of the proton-type zeolite is preferably in a range of 1 to 200. In particular, in a case where the BET specific surface area of the solid acid catalyst is in a range of 300 to 500 m²/g, the Si/Al atom ratio is preferably in a range of 5 to 150, more preferably in a range of 5 to 50, still more preferably in a range of 5 to 30, and particularly preferably in a range of 5 to 20. In a case where the Si/Al atom ratio thereof is in a range of 5 to 50 when the BET specific surface area of the solid acid catalyst is in a range of 300 to 500 m²/g, the conversion ratio of the raw material is significantly improved.

Further, the Si/Al atom ratio can be determined by performing measurement using a solid state NMR method.

### (Raw Material)

Examples of the raw material include formic acid and formic acid alkyl ester. These can also be used alone or in the form of a mixture. Examples of the formic acid alkyl ester include methyl formate and ethyl formate.

### (Decomposition Reaction)

The decomposition reaction of the raw material is performed by bringing the raw material into contact with the solid acid catalyst and heating the raw material to decompose the raw material. Alternatively, the decomposition reaction of the raw material may be performed by bringing the raw material into contact with the solid acid catalyst preliminarily modified with a mineral acid and heating the raw material to decompose the raw material. The contact between the raw material and the solid acid catalyst can be performed by, for example, bringing a gas or liquid containing the raw material into contact with the solid acid catalyst. In a case where a gas containing the raw material is brought into contact with the solid acid catalyst, the raw material may be brought into contact with the solid acid catalyst by generating a gas containing vapor of the raw material from a solution containing the raw material using a vaporizer or the like and supplying the gas to the solid acid catalyst. It is preferable that the contact between the raw material and the solid acid catalyst is performed by bringing a gas containing the raw material into contact with the solid acid catalyst. In this case, the efficiency of the decomposition reaction tends to be improved. Further, in a case where a liquid containing the raw material is used, the concentration of the raw material in the liquid is not particularly limited, but is preferably 40% by mass or greater with respect to the mass of the solution (100% by mass) from the viewpoint of energy efficiency. Examples of the liquid containing the raw material include a formic acid aqueous solution.

The decomposition reaction of the raw material can be performed using a reactor. A reaction tank or a reaction column filled with a catalyst is used as the reactor. In a case where a reaction tank is used as the reactor, carbon monoxide may be generated by charging the reaction tank with a catalyst and the raw material and heating the raw material and the catalyst. In a case where a reaction column filled with a catalyst is used as the reactor, carbon monoxide may be generated, for example, by causing vapor of the raw material to pass through the catalyst filling the reaction column so that the catalyst is heated. From the viewpoint of reaction efficiency, it is preferable to use a reaction column filled with a catalyst as the reactor. The reaction column may be alone, or a plurality of reaction columns may be connected to each other. The reactor formed of a plurality of reaction columns is advantageous in terms of suppressing uneven distribution of the flow rate in the reactor and ensuring a heat transfer area for heating the raw material. Further, in a case where a gas or liquid containing the raw material is continuously supplied to the reactor, the reactor usually has an inlet and an outlet for supplying or discharging the gas or liquid, and the inlet and the outlet are connected to an external flow path.

The reactor is formed of a non-metal material such as carbon. The reactor formed of a non-metal material is unlikely to be corroded by the raw material and carbon monoxide and is unlikely to affect the reaction. In a case where a temperature (reaction temperature) at which the decomposition reaction of the raw materials is performed is a relatively low temperature (for example, 100° C. to 200° C.), a reactor having a surface treated with glass lining can be used as the reactor.

The space velocity (SV) of the gas containing the raw material (hereinafter, referred to as “raw material gas”) is not particularly limited, but is preferably 1000 [l/h] or less. From the viewpoint of further improving the conversion ratio of the raw material, the space velocity of the raw material gas is more preferably 280 [l/h] or less and particularly preferably 240 [l/h] or less. However, the SV thereof is preferably 0.1 [l/h] or greater, more preferably 100 [l/h] or greater, and particularly preferably 200 [l/h] or greater.

The space velocity of the raw material gas denotes a value measured on a normal conversion basis. The space velocity of the raw material gas can be calculated based on the following equation using, for example, the supply velocity (g/h) of the raw material gas, the volume of the solid acid catalyst, and the like.

$$\begin{matrix}Space velocity of raw material gas [ 1 / h ] \\ = supply velocity of raw \\ material gas ( g / h ) \times 0.01 \\ \times concentration of at least one of \\ formic acid or formic acid alkyl ester \\ in raw material gas ( \% by weight ) \\ \div molecular weight of formic acid \\ or formic acid alkyl ester ( g / mol ) \\ \times standard state volume 22.4 ( NL / mol ) \\ \div volume of solid acid catalyst ( L )\end{matrix}$$

Further, in a case where the raw material gas is a gas obtained by vaporizing a liquid containing the raw material (hereinafter, referred to as “raw material liquid”), the expression “concentration of at least one of formic acid or formic acid alkyl ester in the raw material liquid” is defined as “concentration of at least one of formic acid or formic acid alkyl ester in the raw material gas”.

The reaction temperature may be a temperature at which the raw material can be decomposed, but is preferably in a range of 100° C. to 300° C. and more preferably in a range of 100° C. to 200° C. In a case where the reaction temperature is set to 100° C. to 300° C., the reaction tends to efficiently advance while generation of by-products such as hydrogen is suppressed and the concentration of hydrogen in carbon monoxide to be manufactured is sufficiently reduced. For example, in a case where a reaction column filled with a catalyst is used as the reactor and a heater is provided in the vicinity of the solid acid catalyst, the set temperature of the heater is defined as the reaction temperature. The decomposition reaction of the raw material is usually performed in a state where the catalyst, the raw material, or both of the catalyst and the raw material are heated to the above-described temperatures.

The product such as the gas or liquid containing the generated carbon monoxide may contain, as the by-products, extremely small amounts of hydrogen, carbon dioxide, and methane in addition to water. Therefore, the method for manufacturing carbon monoxide may further include a step of removing unreacted raw materials and by-products from a product (a gas or a liquid) containing carbon monoxide, which has been taken out from the reactor and a step of removing water from the product. The raw materials and the by-products can be removed by a usual washing method, and thus high-purity carbon monoxide can be obtained. The raw materials and the carbon dioxide can be easily removed by, for example, caustic soda. The water can be removed, for example, by being cooled or adsorbed to a dehydration material. The purity of carbon monoxide in the product after water, raw materials, and by-products are removed by these steps can be set to 99.99% or greater. Such high-purity carbon monoxide can be used for various applications including the field of manufacturing semiconductors.

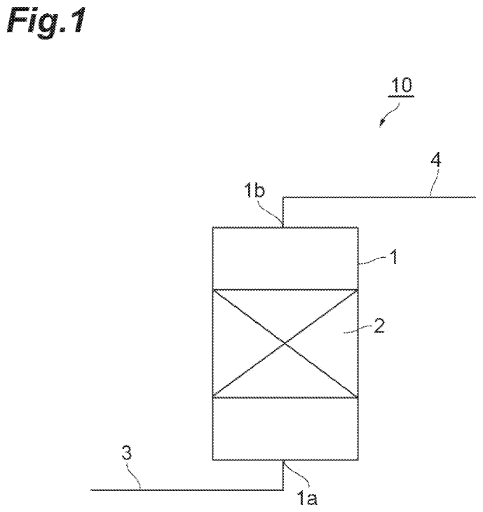

FIG. 1 is a schematic view showing an embodiment of the device for manufacturing carbon monoxide according to the present disclosure. As shown in FIG. 1, a device 10 for manufacturing carbon monoxide according to the present disclosure includes a reactor 1 and a solid acid catalyst 2 stored in the reactor 1. The above-described reactor is used as the reactor 1, and the above-described solid acid catalyst is used as the solid acid catalyst 2. The reactor 1 has an inlet 1a and an outlet 1b for supplying or discharging a gas or a liquid. In the outside of the reactor 1, a flow path 3 that supplies at least one raw material of formic acid or a formic acid alkyl ester is connected to the inlet 1a, and a flow path 4 that discharges a gas or a liquid is connected to the outlet 1b. The device 10 for manufacturing carbon monoxide may further include a heating device (not shown) that heats the solid acid catalyst 2, the raw material, or both of the solid acid catalyst and the raw material, a device (not shown) that removes unreacted raw materials and by-products from a product containing carbon monoxide, and a device (not shown) that removes water from the product, as necessary.

In the device 10 for manufacturing carbon monoxide, the raw material is supplied to the reactor 1 from the inlet 1a through the flow path 3, and passes through the solid acid catalyst 2. Here, carbon monoxide is generated by the decomposition reaction of the raw material in the presence of the solid acid catalyst. The product containing carbon monoxide is discharged from the outlet 1b of the reactor 1 through the flow path 4. In this manner, carbon monoxide is manufactured.

The outline of the present disclosure is as follows.
[1] A method for manufacturing carbon monoxide, including: a step of generating carbon monoxide by a decomposition reaction of at least one raw material of formic acid or formic acid alkyl ester in the presence of a solid acid catalyst, in which the solid acid catalyst has a BET specific surface area of 590 m²/g or less.
[2] The method for manufacturing carbon monoxide according to [1], in which the solid acid catalyst is a proton-type zeolite.
[3] The method for manufacturing carbon monoxide according to [2], in which a Si/Al atom ratio of the proton-type zeolite is in a range of 1 to 200.
[4] The method for manufacturing carbon monoxide according to any one of [1] to [3], in which the decomposition reaction of the raw material is performed at 100° C. to 300° C.
[5] The method for manufacturing carbon monoxide according to any one of [1] to [4], in which the solid acid catalyst has a BET specific surface area of 480 m²/g or less.
[6] A device for manufacturing carbon monoxide, which generates carbon monoxide by a decomposition reaction of at least one raw material of formic acid or formic acid alkyl ester in the presence of a solid acid catalyst, the device including: a reactor storing the solid acid catalyst and generating carbon monoxide by the decomposition reaction of the raw material in the presence of the solid acid catalyst, in which the solid acid catalyst has a BET specific surface area of 590 m²/g or less.
[7] The device for manufacturing carbon monoxide according to [6], in which the solid acid catalyst is a proton-type zeolite.
[8] The device for manufacturing carbon monoxide according to [7], in which a Si/Al atom ratio of the proton-type zeolite is in a range of 1 to 200.
[9] The device for manufacturing carbon monoxide according to [6], in which the solid acid catalyst has a BET specific surface area of 480 m²/g or less.

### EXAMPLES

Hereinafter, the present disclosure will be described in more detail based on examples. However, the present disclosure is not limited to such examples.

### Example 1

A column serving as a reactor having an inner diameter of 2.5 cm and a length of 25 cm was filled with a zeolite catalyst (manufactured by Tosoh Corporation, Si/Al atom ratio: 20, BET specific surface area: 397 m²/g) serving as a solid acid catalyst such that the length thereof was set to 10 cm. The amount of the zeolite catalyst used was 35 g (49 mL). While the column filled with the catalyst was heated from the outside with a heater set at 175° C., vapor of formic acid at 120° C. generated by causing a formic acid aqueous solution having a concentration of 76% by weight to pass through a vaporizer from one end of the column was sent at a supply velocity of 31 g/h. In this manner, the vapor of formic acid was brought into contact with the solid acid catalyst and to cause a decomposition reaction, thereby generating a gas containing carbon monoxide. Here, the space velocity of the vapor (raw material gas) of formic acid was 234 [l/h] on a normal conversion basis.

Thereafter, the gas discharged from the other end of the column was allowed to pass through a caustic soda aqueous solution having a concentration of 20% by weight and water in this order. A trace amount of carbon dioxide contained in the gas was removed by the caustic soda aqueous solution. The gas that had passed through the caustic soda aqueous solution and water was cooled and dried, the amount of hydrogen in the gas was quantified by gas chromatography using a pulsed discharge detector (PDD) as a detector, and the conversion ratio of formic acid and the selectivity to carbon monoxide were determined from the determined amount of hydrogen and the flow rate of the gas. Further, an improvement rate of the conversion ratio based on Comparative Example 1 was calculated. The results are listed in Table 1. As listed in Table 1, the conversion ratio of formic acid was 75%, and the improvement rate of the conversion ratio based on Comparative Example 1 was 134%. Further, the selectivity to carbon monoxide was 99.99% or greater, and the concentration of hydrogen was 2.2 ppm.

In addition, the BET specific surface area of the solid acid catalyst was measured under the following conditions using BEL SORP-MAX (manufactured by MicrotracBEL Corp.) as an analysis device.

### (Conditions)

Measurement temperature: −196° C.
Adsorbate: nitrogen
Equilibrium absorption time: 300 seconds
Conditions for pretreatment of solid acid catalyst: heat treatment (350° C., 5 h) in vacuum (pump specification: ultimate pressure of 6.7×10⁻⁷ Pa or less)

### Example 2

The reaction was performed in the same manner as in Example 1 except that 39 g (49 mL) of a zeolite catalyst (manufactured by Tosoh Corporation, Si/Al atom ratio: 110, BET specific surface area: 477 m²/g) was used as the solid acid catalyst filling the column, thereby generating a gas containing carbon monoxide. Thereafter, the conversion ratio of formic acid and the selectivity to carbon monoxide were determined in the same manner as in Example 1, and the improvement rate of the conversion ratio based on Comparative Example 1 was calculated. The results are listed in Table 1. As listed in Table 1, the conversion ratio of formic acid was 60%, and the improvement rate of the conversion ratio based on Comparative Example 1 was 88%. Further, the selectivity to carbon monoxide was 99.99% or greater. Further, the gas that had passed through the caustic soda aqueous solution and water was cooled and dried, the amount of hydrogen in the gas was quantified by gas chromatography using a PDD as a detector, and the concentration of hydrogen was determined from the determined amount of hydrogen and the flow rate of the gas. The results are listed in Table 1. As listed in Table 1, the concentration of hydrogen was 4.9 ppm.

### Example 3

The reaction was performed in the same manner as in Example 1 except that 36 g (49 mL) of a zeolite catalyst (manufactured by Tosoh Corporation, Si/Al atom ratio: 9, BET specific surface area: 485 m²/g) was used as the solid acid catalyst filling the column, thereby generating a gas containing carbon monoxide. Thereafter, the conversion ratio of formic acid and the selectivity to carbon monoxide were determined in the same manner as in Example 1, and the improvement rate of the conversion ratio based on Comparative Example 1 was calculated. The results are listed in Table 1. As listed in Table 1, the conversion ratio of formic acid was 73%, and the improvement rate of the conversion ratio based on Comparative Example 1 was 128%. Further, the selectivity to carbon monoxide was 99.99% or greater, and the concentration of hydrogen was 6.9 ppm.

### Example 4

The reaction was performed in the same manner as in Example 1 except that 35 g (49 mL) of a zeolite catalyst (manufactured by Tosoh Corporation, Si/Al atom ratio: 20, BET specific surface area: 571 m²/g) was used as the solid acid catalyst filling the column, thereby generating a gas containing carbon monoxide. Thereafter, the conversion ratio of formic acid and the selectivity to carbon monoxide were determined in the same manner as in Example 1, and the improvement rate of the conversion ratio based on Comparative Example 1 was calculated. The results are listed in Table 1. As listed in Table 1, the conversion ratio of formic acid was 62%, and the improvement rate of the conversion ratio based on Comparative Example 1 was 94%. Further, the selectivity to carbon monoxide was 99.99% or greater, and the concentration of hydrogen was 6.9 ppm.

### Example 5

A column serving as a reactor having an inner diameter of 2.5 cm and a length of 25 cm was filled with a zeolite catalyst (manufactured by Tosoh Corporation, Si/Al atom ratio: 12, BET specific surface area: 381 m²/g) serving as a solid acid catalyst such that the length thereof was set to 10 cm. The amount of the zeolite catalyst used was 40 g (49 mL). While the column filled with the catalyst was heated from the outside with a heater set at 175° C., vapor of formic acid at 120° C. generated by causing a formic acid aqueous solution having a concentration of 76% by weight to pass through a vaporizer from one end of the column was sent at a supply velocity of 31 g/h. In this manner, the vapor of formic acid was brought into contact with the solid acid catalyst and to cause a decomposition reaction, thereby generating a gas containing carbon monoxide. Here, the space velocity of the vapor (raw material gas) of formic acid was 234 [l/h] on a normal conversion basis.

Thereafter, the carbon monoxide discharged from the other end of the column was allowed to pass through a caustic soda aqueous solution having a concentration of 20% by weight and water in this order. A trace amount of carbon dioxide contained in the carbon monoxide was removed by the caustic soda aqueous solution. Further, the gas that had passed through the caustic soda aqueous solution and water was cooled and dried, the amount of hydrogen in the carbon monoxide was quantified by gas chromatography using a PDD as a detector, and the conversion ratio of formic acid, the selectivity to carbon monoxide, and the concentration of hydrogen were determined from the determined amount of hydrogen and the flow rate of the gas. The results are listed in Table 1. As listed in Table 1, the conversion ratio of formic acid was 89%, and the improvement rate of the conversion ratio based on Comparative Example 1 was 178%. Further, the selectivity to carbon monoxide was 99.99% or greater, and the concentration of hydrogen was 1.8 ppm.

In addition, the BET specific surface area of the solid acid catalyst was measured under the same conditions as in Example 1 using the same analysis device as in Example 1.

### Comparative Example 1

The reaction was performed in the same manner as in Example 1 except that 34 g (49 mL) of a zeolite catalyst (manufactured by Tosoh Corporation, Si/Al atom ratio: 15, BET specific surface area: 599 m²/g) was used as the solid acid catalyst filling the column, thereby generating a gas containing carbon monoxide. Further, the conversion ratio of formic acid and the selectivity to carbon monoxide were determined in the same manner as in Example 1. The results are listed in Table 1. As listed in Table 1, the conversion ratio of formic acid was 32%, and the selectivity to carbon monoxide was 99.99% or greater. Further, Comparative Example 1 was used as a reference for the improvement rate of the conversion ratio, and thus the improvement rate of the conversion ratio of Comparative Example 1 was listed as “-” in Table 1. Further, the concentration of hydrogen was also determined in the same manner as in Example 5. The results are listed in Table 1. As listed in Table 1, the concentration of hydrogen was 11 ppm.

### Comparative Example 2

The reaction was performed in the same manner as in Example 1 except that 32 g (49 mL) of a zeolite catalyst (manufactured by Tosoh Corporation, Si/Al atom ratio: 3, BET specific surface area: 614 m²/g) was used as the solid acid catalyst filling the column, thereby generating a gas containing carbon monoxide. Thereafter, the conversion ratio of formic acid and the selectivity to carbon monoxide were determined in the same manner as in Example 1, and the improvement rate of the conversion ratio based on Comparative Example 1 was calculated. The results are listed in Table 1. As listed in Table 1, the conversion ratio of formic acid was 22%, and the improvement rate of the conversion ratio based on Comparative Example 1 was-31%. Further, the selectivity to carbon monoxide was 99.99% or greater. Further, the concentration of hydrogen was also determined in the same manner as in Example 5. The results are listed in Table 1. As listed in Table 1, the concentration of hydrogen was 90 ppm.

### Comparative Example 3

The reaction was performed in the same manner as in Example 5 except that 35 g (49 mL) of a zeolite catalyst (manufactured by Tosoh Corporation, Si/Al atom ratio: 3, BET specific surface area: 662 m²/g) was used as the solid acid catalyst filling the column, thereby generating a gas containing carbon monoxide. Thereafter, the conversion ratio of formic acid, the selectivity to carbon monoxide, and the concentration of hydrogen were determined in the same manner as in Example 5. The results are listed in Table 1. As listed in Table 1, the conversion ratio of formic acid was 21%, and the improvement rate of the conversion ratio based on Comparative Example 1 was-34%. Further, the selectivity to carbon monoxide was 99.93% or greater, and the concentration of hydrogen was 644 ppm.

TABLE 1

| | | | | Improvement rate | | |
|---|---|---|---|---|---|---|
| | Solid acid | | | of conversion ratio | | |
| | catalyst | | | (based on | | |
| | BET specific | Si/Al | Conversion | Comparative | | Concentration |
| | surface area | atom | ratio | Example 1) | Selectivity | of hydrogen |
| | (m²/g) | ratio | (%) | (%) | (%) | (ppm) |
| Example 1 | 397 | 20 | 75 | 134 | 99.99 or | 2.2 |
| | | | | | greater | |
| Example 2 | 477 | 110 | 60 | 88 | 99.99 or | 4.9 |
| | | | | | greater | |
| Example 3 | 485 | 9 | 73 | 128 | 99.99 or | 6.9 |
| | | | | | greater | |
| Example 4 | 571 | 20 | 62 | 94 | 99.99 or | 6.9 |
| | | | | | greater | |
| Example 5 | 381 | 12 | 89 | 178 | 99.99 or | 1.8 |
| | | | | | greater | |
| Comparative | 599 | 15 | 32 | — | 99.99 or | 11 |
| Example 1 | | | | | greater | |
| Comparative | 614 | 3 | 22 | −31 | 99.99 or | 90 |
| Example 2 | | | | | greater | |
| Comparative | 662 | 3 | 21 | −34 | 99.93 or | 644 |
| Example 3 | | | | | greater | |

As shown in the results listed in Table 1, it was found that, the improvement rates of the conversion ratios of the raw materials in Examples 1 to 5 were significantly high as compared with those in Comparative Examples 1 to 3.

Based on these results, it was confirmed that when the BET specific surface area of the solid acid catalyst is set to 590 m²/g or less, the conversion ratio of the raw material can be improved as compared with a case where the BET specific surface area of the solid acid catalyst is greater than 590 m²/g.

As shown in the results listed in Table 1, it was also found that, the concentrations of hydrogen in carbon monoxide in Examples 1 to 5 were significantly decreased as compared with those in Comparative Examples 1 to 3.

As shown in these results, it was confirmed that when the BET specific surface area of the solid acid catalyst is set to 590 m²/g or less, the concentration of hydrogen in carbon monoxide manufactured can be sufficiently reduced without performing a purification step of removing hydrogen as compared with a case where the BET specific surface area of the solid acid catalyst is greater than 590 m²/g.

### REFERENCE SIGNS LIST

1: reactor
1a: inlet
1b: outlet
2: solid acid catalyst
3, 4: flow path
10: device for manufacturing carbon monoxide

1. A method for manufacturing carbon monoxide, comprising:
a step of generating carbon monoxide by a decomposition reaction of at least one raw material of formic acid or formic acid alkyl ester in the presence of a solid acid catalyst,
wherein the solid acid catalyst has a BET specific surface area of 590 m²/g or less.

2. The method for manufacturing carbon monoxide according to claim 1,
wherein the solid acid catalyst is a proton-type zeolite.

3. The method for manufacturing carbon monoxide according to claim 2,
wherein a Si/Al atom ratio of the proton-type zeolite is in a range of 1 to 200.

4. The method for manufacturing carbon monoxide according to claim 1,
wherein the decomposition reaction of the raw material is performed at 100° C. to 300° C.

5. The method for manufacturing carbon monoxide according to claim 1,
wherein the solid acid catalyst has a BET specific surface area of 480 m²/g or less.

6. A device for manufacturing carbon monoxide, which generates carbon monoxide by a decomposition reaction of at least one raw material of formic acid or formic acid alkyl ester in the presence of a solid acid catalyst, the device comprising:
a reactor storing the solid acid catalyst and generating carbon monoxide by the decomposition reaction of the raw material in the presence of the solid acid catalyst,
wherein the solid acid catalyst has a BET specific surface area of 590 m²/g or less.

7. The device for manufacturing carbon monoxide according to claim 6,
wherein the solid acid catalyst is a proton-type zeolite.

8. The device for manufacturing carbon monoxide according to claim 7,
wherein a Si/Al atom ratio of the proton-type zeolite is in a range of 1 to 200.

9. The device for manufacturing carbon monoxide according to claim 6,
wherein the solid acid catalyst has a BET specific surface area of 480 m²/g or less.
